(19) United States
(12) Patent Application Publication
(10) Pub. No.: US 2026/0058941 A1
(43) Pub. Date: Feb. 26, 2026

(54) LOCAL ACCESS TOKEN VERIFICATION

(71) Applicant: International Business Machines Corporation, Armonk, NY (US)

(72) Inventors: Shuo Zhang, Beijing (CN); Da Guang Sun, Changping (CN); Jing Jing Wei, Beijing (CN); Ping Mei, Beijing (CN); Bing Ding, Beijing (CN); Zhong Tao Gao, Beijing (CN)

(21) Appl. No.: 18/815,609

(22) Filed: Aug. 26, 2024

(51) Int. Cl. H04L 9/40

(52) U.S. Cl. CPC H04L 63/0807; H04L 63/10

(57) ABSTRACT

A method, according to one approach, includes: receiving an access request targeting a first resource server. Moreover, a request is sent to an authorization server for an access token associated with performing the access request. The method also includes causing a key identification (ID) to be extracted from the requested access token received from the authorization server. The key ID is compared against cryptographic keys previously received at the first resource server. In response to the key ID matching one of the cryptographic keys previously received at the first resource server, the matching previously received cryptographic key is used to verify the access token. Moreover, in response to the access token being verified, causing the access request to be granted.

### BACKGROUND

The present invention relates to access tokens, and more specifically, this invention relates to revocation of access tokens.

Data production has continued to increase, particularly as computing power and the use of Internet of Things (IoT) devices continue to advance. For instance, the rise of smart enterprise endpoints has led to large amounts of data being generated at remote locations. Data production will only further increase with the growth of 5G networks and an increased number of connected mobile devices. This has also become more prevalent as the complexity of machine learning models increases.

While cloud computing has been implemented in some conventional systems in an effort to improve the ability to process this increasing amount of data, moving sensitive workloads to the cloud exposes them to significant security risks. For example, the process of moving certain workloads to cloud for computation efficiency assumes (e.g., requires) the cloud to be secure. Cryptography allows for some security to be introduced to workloads and data that are exposed to public environments, but has also introduced unique security considerations.

For example, authorization servers provide verified users access to authorization tokens which provide the client with the ability to access corresponding resources. However, the authorization tokens (also referred to herein as access tokens) and ability to access the respective resources can be shared with other clients. In other words, the authorization tokens can be shared between different clients to easily allow them access to the different resources at the respective locations.

### SUMMARY

A method, according to one approach, includes: receiving an access request targeting a first resource server. Moreover, a request is sent to an authorization server for an access token associated with performing the access request. The method also includes causing a key identification (ID) to be extracted from the requested access token received from the authorization server. The key ID is compared against cryptographic keys previously received at the first resource server. In response to the key ID matching one of the cryptographic keys previously received at the first resource server, the matching previously received cryptographic key is used to verify the access token. Moreover, in response to the access token being verified, causing the access request to be granted.

A computer program product, according to another approach, includes: one or more computer-readable storage media. The computer program product also includes program instructions that are stored on the one or more storage media to perform the foregoing method.

A computer system, according to yet another approach, includes: a processor set, and one or more computer-readable storage media. The computer system also includes program instructions that are stored on the one or more storage media to cause the processor set to perform the foregoing method.

Other aspects and implementations of the present invention will become apparent from the following detailed description, which, when taken in conjunction with the drawings, illustrate by way of example the principles of the invention.

### BRIEF DESCRIPTION OF THE DRAWINGS

FIG. 1 is a diagram of a computing environment, in accordance with one approach.

FIG. 2A is a representational view of a distributed system, in accordance with one approach.

FIG. 2B is a representational view of a system having a logic system group, in accordance with one approach.

FIG. 3A is a flowchart of a method, in accordance with one approach.

FIG. 3B is a flowchart of sub-operations for one of the operations in the method of FIG. 3A, in accordance with one approach.

### DETAILED DESCRIPTION

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The following description discloses several preferred approaches of systems, methods, and computer program products for improving the control and efficiency with which access tokens are issued and revoked across a system is illustrated in accordance with one approach. Approaches herein may thereby achieve access token revocation without performing any introspection checks (e.g., at authorization servers) for the respective revocations. This significantly reduces compute overhead and improves system performance, e.g., as will be described in further detail below.

In one general approach, a method includes: receiving an access request targeting a first resource server. Moreover, a request is sent to an authorization server for an access token associated with performing the access request. The method also includes causing a key identification (ID) to be extracted from the requested access token received from the authorization server. The key ID is compared against cryptographic keys previously received at the first resource server. In response to the key ID matching one of the cryptographic keys previously received at the first resource server, the matching previously received cryptographic key is used to verify the access token. Moreover, in response to the access token being verified, causing the access request to be granted.

In another general approach, a computer program product includes: one or more computer-readable storage media. The computer program product also includes program instructions that are stored on the one or more storage media to perform the foregoing method.

In yet another general approach, a computer system includes: a processor set, and one or more computer-readable storage media. The computer system also includes program instructions that are stored on the one or more storage media to cause the processor set to perform the foregoing method.

Various aspects of the present disclosure are described by narrative text, flowcharts, block diagrams of computer systems and/or block diagrams of the machine logic included in computer program product (CPP) approaches. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product approach (“CPP approach” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as improved access token revocation code at block 150 for improving the control and efficiency with which access tokens are issued and revoked across a system is illustrated in accordance with one approach. Approaches herein may thereby achieve access token revocation without performing any introspection checks (e.g., at authorization servers) for the respective revocations. This significantly reduces compute overhead and improves system performance, e.g., as will be described in further detail below.

In addition to block 150, computing environment 100 includes, for example, computer 101, wide area network (WAN) 102, end user device (EUD) 103, remote server 104, public cloud 105, and private cloud 106. In this approach, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI) device set 123, storage 124, and IoT sensor set 125), and network module 115. Remote server 104 includes remote database 130. Public cloud 105 includes gateway 140, cloud orchestration module 141, host physical machine set 142, virtual machine set 143, and container set 144.

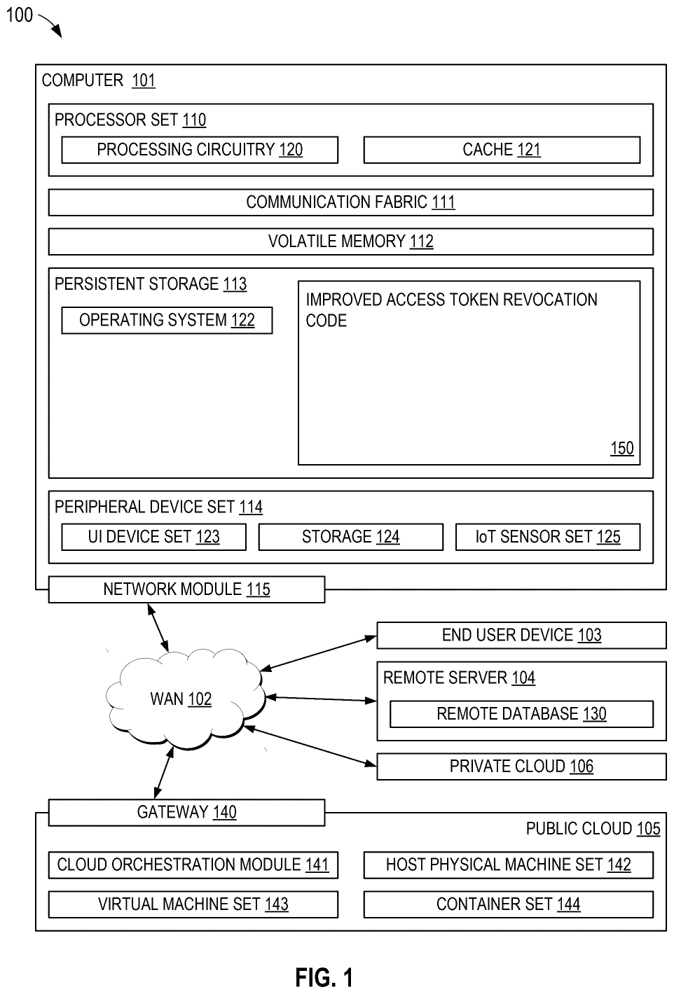

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various approaches, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some approaches, storage 124 may take the form of a quantum computing storage device for storing data in the form of qubits. In approaches where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer, and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some approaches, network control functions and network forwarding functions of network module 115 are performed on the same physical hardware device. In other approaches (for example, approaches that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some approaches, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some approaches, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other approaches a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this approach, public cloud 105 and private cloud 106 are both part of a larger hybrid cloud.

CLOUD COMPUTING SERVICES AND/OR MICROSERVICES (not separately shown in FIG. 1): private and public clouds 106 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some approaches, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of application programming interfaces (APIs). One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

In some aspects, a system according to various approaches may include a processor and logic integrated with and/or executable by the processor, the logic being configured to perform one or more of the process steps recited herein. The processor may be of any configuration as described herein, such as a discrete processor or a processing circuit that includes many components such as processing hardware, memory, I/O interfaces, etc. By integrated with, what is meant is that the processor has logic embedded therewith as hardware logic, such as an application specific integrated circuit (ASIC), a FPGA, etc. By executable by the processor, what is meant is that the logic is hardware logic; software logic such as firmware, part of an operating system, part of an application program; etc., or some combination of hardware and software logic that is accessible by the processor and configured to cause the processor to perform some functionality upon execution by the processor. Software logic may be stored on local and/or remote memory of any memory type, as known in the art. Any processor known in the art may be used, such as a software processor module and/or a hardware processor such as an ASIC, a FPGA, a central processing unit (CPU), an integrated circuit (IC), a graphics processing unit (GPU), etc.

Of course, this logic may be implemented as a method on any device and/or system or as a computer program product, according to various approaches.

As noted above, data production has continued to increase, particularly as computing power and the use of IoT devices continue to advance. For instance, the rise of smart enterprise endpoints has led to large amounts of data being generated at remote locations. Data production will only further increase with the growth of 5G networks and an increased number of connected mobile devices.

This issue has also become more prevalent as the complexity of machine learning models increases. Increasingly complex machine learning models translate to more intense workloads and increased strain associated with applying the models to received data. The operation of conventional implementations has thereby been negatively impacted.

While cloud computing has been implemented in some conventional systems in an effort to improve the ability to process this increasing amount of data, moving sensitive workloads to the cloud exposes them to significant security risks. For example, the process of moving certain workloads to cloud for computation efficiency assumes (e.g., requires) the cloud to be secure. Cryptography allows for some security to be introduced to workloads and data that are exposed to public environments, but has also introduced unique security risks that have plagued conventional products.

For example, authorization servers provide verified users access to authorization tokens which provide the client with the ability to access corresponding resources. However, the authorization tokens (also referred to herein as access tokens) and ability to access the respective resources can be shared with other clients. In other words, the authorization tokens can be shared between different clients to easily allow them access to the different resources at the respective locations. While this increases resource access, conventional products have been unable to revoke the authorization tokens themselves after they are shared, causing security issues to arise. For instance, after a client is issued a credential, conventional products have attempted to implement set expiration times that revoke the ability for a client to use credentials that have been shared as the authorization tokens to access the resources at a resource server. However, fixed expiration times lead to a significant number of situations where access is revoked too early or too late to achieve reliable security or functionality.

Attempts have also been made to improve access revocation capabilities by performing access token verification steps during each resource access attempt. While this allows for access tokens to be verified before use, it significantly increases the compute overhead associated with performing each resource access request. This undesirably leads to significant decreases in system throughput and increases in resource consumption overall.

In sharp contrast to these conventional shortcomings, approaches herein are able to improve the control and efficiency with which access tokens are issued and revoked across a system. Approaches herein may thereby be performed to issue access tokens to desired locations in addition to effectively revoking tokens after they have been issued and even shared between locations (e.g., clients). Approaches herein are further able to achieve this token revocation without performing any introspection checks (e.g., at authorization servers) for each revocation. Approaches herein are thereby able to significantly reduce the compute overhead experienced by systems in an attempt to achieve some rudimentary level of cryptographic token revocation, e.g., as will be described in further detail below.

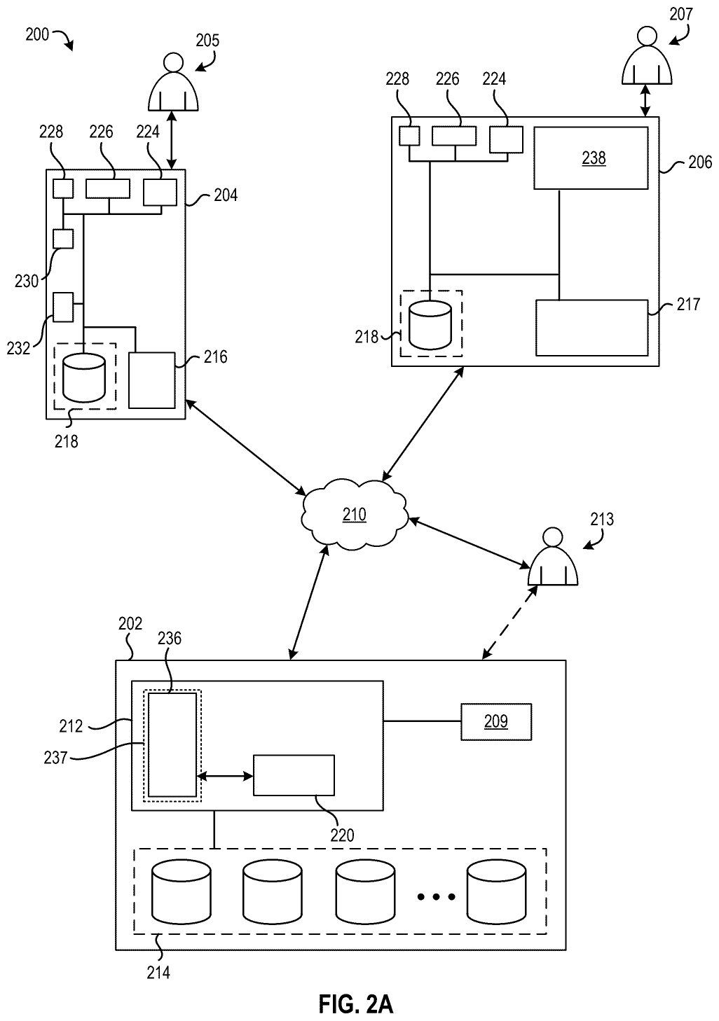

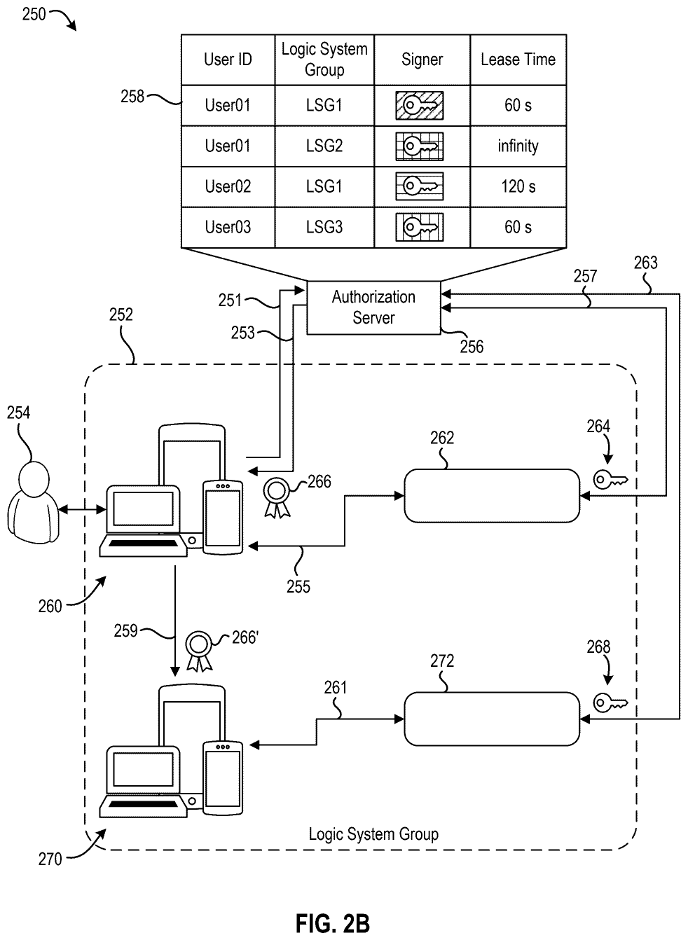

Looking now to FIG. 2A, a distributed data storage system 200 in accordance with one approach. As an option, the present system 200 may be implemented in conjunction with features from any other approach listed herein, such as those described with reference to the other FIGS. However, this distributed data storage system 200 and others presented herein may be used in various applications and/or in permutations which may or may not be specifically described in the illustrative approaches or implementations listed herein. Further, the system 200 presented herein may be used in any desired environment. Thus FIG. 2A (and the other FIGS.) may be deemed to include any possible permutation.

As shown, the distributed data storage system 200 includes a central server 202 that is connected to user device 204 and edge node 206. Specifically, the central server 202, user device 204, and edge node 206 are connected to a network 210 that allows for data (e.g., information, commands, requests, instructions, responses, encrypted data, etc.) to be sent between any of the locations 202, 204, 206.

The network 210 may be of any type, e.g., depending on the desired approach. For instance, in some approaches the network 210 is a WAN, e.g., such as the Internet. However, an illustrative list of other network types which network 210 may implement includes, but is not limited to, a LAN, a PSTN, a SAN, an internal telephone network, etc. As a result, any desired information, data, commands, instructions, responses, requests, etc. may be sent between the locations 202, 204, 206, regardless of the amount of separation which exists therebetween, e.g., despite being positioned at different geographical locations. It should also be noted that the different locations 202, 204, 206 may be connected to each other (and/or other locations) differently depending on the approach. According to an example, two host locations may be located relatively close to each other and connected by a wired connection, e.g., a cable, a fiber-optic link, a wire, etc.; etc., or any other type of connection which would be apparent to one skilled in the art after reading the present description.

With continued reference to FIG. 2A, the user device 204 and edge node 206 may have different configurations than the central server 202. For example, in some implementations the central server 202 includes a large (e.g., robust) processor 212 coupled to a cache 209 and memory 214 having a relatively high storage capacity. The central server 202 is thereby able to process and store a relatively large amount of data, allowing it to be connected to, and manage, multiple different remote locations. For example, edge node 206 may generate or receive cryptographic signatures that are stored and/or managed at a secure software environment of central server 202 (e.g., see authorization server 256 of FIG. 2B). The edge node 206 itself may also include a secure software environment (e.g., an authorization server) in some approaches. For example, the controller 217 may include a secure software environment therein.

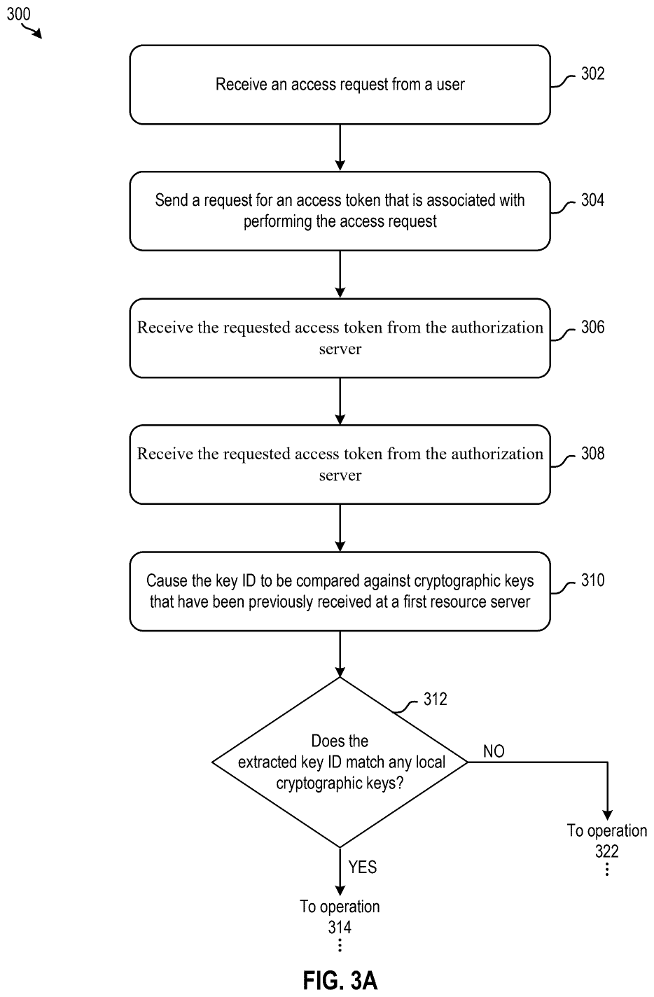

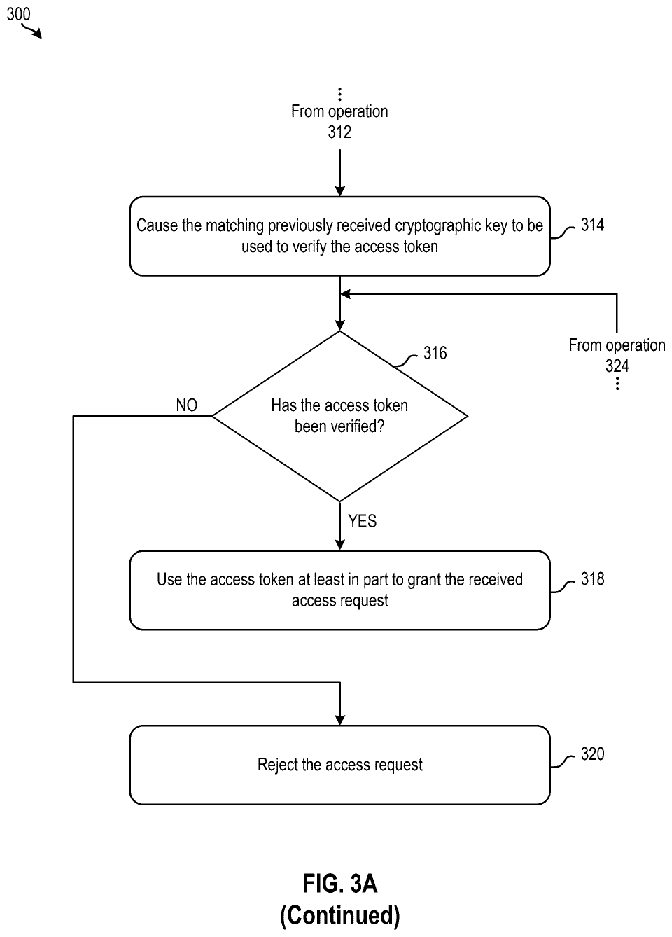

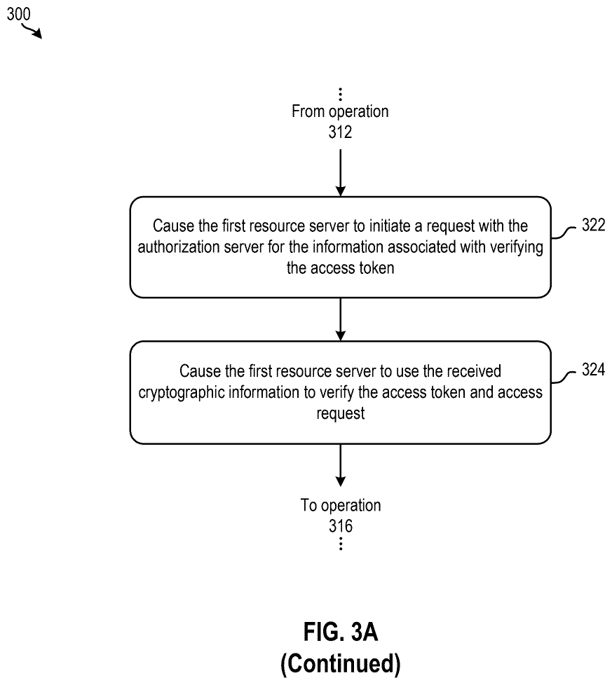

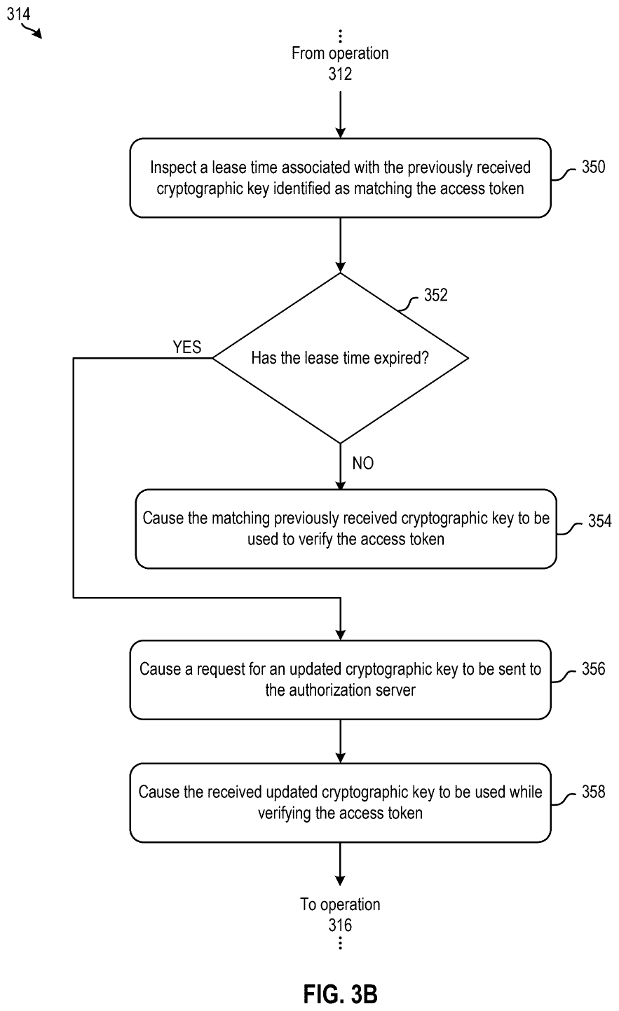

It should be noted that with respect to the present description, “resources” may include any desired type of components and/or information. For instance, in some implementations, resources include data such as raw sensor data, metadata, program commands, instructions, etc. In other implementations, resources may include physical and/or logical components that are configured to perform certain operations. Moreover, while implementations herein are described in the context of resources that are protected using access tokens, this is in no way intended to be limiting. Resources may also be protected with different types of security features depending on the approach. According to some approaches, the way in which data is protected has an impact on how that data may be processed and/or stored. For instance, the processor 212 may use a secure software environment 236 to process incoming data that is encrypted. However, the secure software environment 236 may only be accessed by a secure engine 220. Accordingly, the processor 212 and/or the secure software environment 236 therein may be used to perform one or more operations in method 300 of FIG. 3A below.

With continued reference to FIG. 2A, the secure software environment 236 may be designed (e.g., custom built) to have certain characteristics and/or functionality. For instance, the secure software environment 236 may be used to generate and/or store access tokens that permit interaction with desired resources. The secure software environment may be modified as desired, e.g., to apply one or more encryption and/or decryption keys, add trusted (compliant) hashing algorithm details, etc. In some approaches, the secure software environment is a plugin-based software package that is modified by a host and sent to central server 202 for implementation. It should also be noted that access tokens (e.g., key identifications (IDs)) may be shared between locations. Thus, access tokens can be sent from the secure software environment 236 at central server 202 to a secure environment (not shown) in the edge node 206. Sharing access tokens in this manner allows for access to the underlying protected resources to be shared as well, e.g., as described in further detail below with respect to FIG. 2B.

Referring momentarily to FIG. 2B, a detailed view of a system 250 having a logic system group 252 is illustrated in accordance with one approach. As an option, the present system 250 may be implemented in conjunction with features from any other approach listed herein, such as those described with reference to the other FIGS. It follows that one or more of the components depicted in FIG. 2B may be implemented in FIG. 2A. According to a non-limiting example, the authorization server 256 in FIG. 2B may be included at a central server (e.g., see central server 202 of FIG. 2A), while the logic system group 252 is located at an edge node (e.g., see edge node 206 of FIG. 2A). In another non-limiting example, the authorization server 256 and logic system group 252 in FIG. 2B may be included at a central server (e.g., see central server 202 of FIG. 2A). In still another non-limiting example, the authorization server 256 and logic system group 252 in FIG. 2B may be included at an edge node (e.g., see edge node 206 of FIG. 2A). However, this detailed view of the system 250 and others presented herein may be used in various applications and/or in permutations which may or may not be specifically described in the illustrative approaches or implementations listed herein. Further, the system 250 presented herein may be used in any desired environment. Thus FIG. 2B (and other FIGS.) may be deemed to include any possible permutation.

As shown, a user 254 (e.g., client) is connected to a first client location 260. In some situations, the user 254 may wish to gain access to (e.g., use) the resources that are included in a first resource server 262. Accordingly, an access token request is sent from the first client location 260 to the authorization server 256 in operation 251. The request may be sent on behalf of the user 254 in response to the first client location 260 receiving one or more instructions from the user 254, in response to a predetermined condition being met (e.g., at the first client location 260), automatically following user 254 connecting to the first client location 260, etc.

In response to receiving the request from the first client location 260, the authorization server 256 makes one or more determinations that impact how and/or whether the user 254 is given access to the requested first resource server 262. In some approaches, the authorization server 256 determines whether an access token exists for the respective user 254. This may involve inspecting the entries of a lookup table 258 for cryptographic information (e.g., a cryptographic key pair) that has already been generated for the user 254. In response to identifying an existing cryptographic information that corresponds to user 254, an access token and/or other details that are correlated with (e.g., included in) the identified existing cryptographic information may be extracted. For example, an access token correlated with existing cryptographic information may be accessed and copied before being sent to first client location 260. However, it should be noted that in situations where the authorization server 256 does not include any cryptographic information that has already been generated for the user 254, the authorization server 256 may generate a new access token and other corresponding cryptographic information that is assigned to user 254 and added to the lookup table 258.

In response to identifying cryptographic information in the lookup table 258 that corresponds to the user 254, the authorization server 256 extracts an access token and other corresponding cryptographic information from the respective entry in the lookup table 258. For instance, the lookup table 258 is shown as including the User IDs that correspond to each of the respective access tokens, the Logic System Groups that the access token requests are received from, the Signers (e.g., cryptographic key pairs) that have been generated and assigned to each of the access tokens, and the Lease Times of each respective access token. In other words, each row of the lookup table 258 may correspond to a respective access token. With respect to the present description, the “Lease Time” is intended to refer to an amount of time that the respective access token may be lent to a requesting entity (e.g., such as user 254 and/or first client location 260) without performing any additional authorization verifications. For example, the access token generated and assigned to User01 for LSG1 may be re-authorized each 60 second interval, while the access token generated and assigned to User01 for LSG2 has an infinite Lease Time and may thereby not be re-authorized during use. In some approaches, the access token may be (e.g., include) a JSON Web Token (JWT). The access token may thereby include a header portion, a payload portion, and a signature portion, each separated by a period (i.e., “.”). Moreover, the access token may include information that corresponds to a respective cryptographic key pair, e.g., such as important identification information that may include key type, key identifier information, a cryptographic algorithm used to form the key, etc.

From authorization server 256, the access token 266 and other corresponding cryptographic information (e.g., cryptographic key ID) extracted from the respective entry in the lookup table 258 is sent to the first client location 260. See operation 253. In response to receiving the access token 266, user 254 is able to access and interact with the resources (e.g., processors, memory, controllers, applications, etc.) that are included at the first resource server 262. In other words, the access token 266 received from the authorization server 256 allows user 254 to send instructions, commands, data, requests, etc., to the first resource server 262, and vice versa. In some approaches, the user 254 submits access requests to the first resource server 262 through (e.g., using) the first client location 260. Accordingly, operation 255 includes submitting the received access token 266, along with an access request, from the first client location 260 to the first resource server 262.

In response to receiving the access token and access request, the first resource server 262 extracts a corresponding key ID from the access token. The first resource server 262 preferably uses the key ID to inspect local memory for existing cryptographic information that matches the key ID. In other words, the first resource server 262 compares a key ID received with the access token to different cryptographic entries that are stored at the first resource server 262 itself (e.g., in local cache). In response to identifying local cryptographic information that matches the access token received from first client location 260, the access token is verified locally. In other words, the cryptographic information identified in memory of the first resource server 262 as matching the access token submitted by first client location 260 may be used to verify the legitimacy of the access token at the first resource server 262. This is performed without sending any requests and/or instructions outside the logic system group 252, and in preferred approaches, without sending any requests and/or instructions outside the first resource server 262 itself. This allows for cryptographic information already stored locally at the first resource server 262 to be utilized before interacting with remote locations. Approaches herein are thereby desirably able to reduce network traffic, compute overhead, and latency.

However, in situations where cryptographic information correlated with the received access token is not identified in local memory, the first resource server 262 initiates a request with the authorization server 256. See operation 257. The first resource server 262 may send a request to the authorization server 256 for a Signer that is correlated with the received access token. In other words, the first resource server 262 requests cryptographic information from the authorization server 256 that may be used to verify authenticity of the access request received from the first client location 260.

The authorization server 256 thereby uses any information associated with this request to determine whether the access token is active (e.g., has not been revoked or expired). For instance, the authorization server 256 may compare the access token and/or extracted key ID to various existing access channels between client locations and resource servers of a given logic system group. In response to determining the received access token and corresponding key ID do not match any active entries in lookup table 258, the authorization server 256 may return a warning to the first resource server 262 that ultimately rejects the access request received from first client location 260. However, in response to determining the received access token and corresponding key ID do match an active entry in lookup table 258, the authorization server 256 may return a copy of the respective Signer (e.g., private and/or public cryptographic keys) to the first resource server 262. Operation 257 may thereby include sharing the public and/or private key(s) 264 that correspond to the received access token. The first resource server 262 may use this received cryptographic information to determine whether the access request and access token received from first client location 260 are authentic.

While the access token 266 was issued from the authorization server 256 to the first client location 260, it may be copied and shared with other locations to expand access to resources. For example, user 254 and/or a different user (not shown) may wish to access a second resource server 272 using a second client location 270. Accordingly, the access token 266 may be copied and sent to the second client location 270. See operation 259. The access token copy 266′ may thereby be sent from the second client location 270 to the second resource server 272 along with an access request. See operation 261.

In response to receiving the access token and access request, the second resource server 272 extracts the corresponding key ID from the access token and preferably uses the key ID to inspect local memory for existing cryptographic information that matches the key ID. In other words, the second resource server 272 compares a key ID received with the access token to different cryptographic entries that are stored at the second resource server 272 itself (e.g., in local cache). In response to identifying local cryptographic information that matches the access token received from second client location 270, the access token is verified locally. In other words, the cryptographic information identified in memory of the second resource server 272 as matching the access token submitted by second client location 270 may be used to verify the legitimacy of the access token at the second resource server 272. This is performed without sending any requests and/or instructions outside the logic system group 252, and in preferred approaches, without sending any requests and/or instructions outside the second resource server 272 itself. This allows for cryptographic information already stored locally at the second resource server 272 (or elsewhere in the logic system group 252) to be utilized before interacting with remote locations. Approaches herein are again desirably able to reduce network traffic, compute overhead, and latency.

However, in situations where cryptographic information correlated with the received access token is not identified in local memory, the second resource server 272 initiates a request with the authorization server 256. See operation 263. The second resource server 272 may send a request to the authorization server 256 for a Signer that is correlated with the received access token. In other words, the second resource server 272 requests cryptographic information from the authorization server 256 that may be used to verify authenticity of the access request received from the second client location 270.

The authorization server 256 thereby uses any information associated with this request to determine whether the access token is active (e.g., has not been revoked or expired). For instance, the authorization server 256 may compare the access token and/or extracted key ID to various existing access channels between client locations and resource servers of a given logic system group. In response to determining the received access token and corresponding key ID do not match any active entries in lookup table 258, the authorization server 256 may return a warning to the second resource server 272 that ultimately rejects the access request received from second client location 270. However, in response to determining the received access token and corresponding key ID do match an active entry in lookup table 258, the authorization server 256 may return a copy of the respective Signer (e.g., private and/or public cryptographic keys) to the second resource server 272. Operation 263 may thereby include sharing the public and/or private key(s) 268 that correspond to the received access token. The second resource server 272 may use this received cryptographic information to determine whether the access request and access token received from second client location 270 are authentic.

Referring back now to the central server 202 of FIG. 2A, the secure software environment 236 is preferably only accessible to the secure engine 220, and is inaccessible to a remainder of the processor 212. In other words, a logical boundary 237 may only be crossed by secure engine 220, and the logical boundary 237 prevents any other aspects of the processor 212 from accessing the secure software environment 236 or any data being processed therein. Software being run outside the logical boundary 237—other than any software running in the secure engine 220—is thereby unable to directly access any data being processed by software running in the secure software environment 236.

The ability to insulate the secure software environment 236 from exterior access effectively hides any cryptographic information, data, etc., that is sent to and/or generated at the secure software environment 236. Thus, although the secure software environment 236 is located at the central server 202, it may implement confidential details without exposing them to the central server 202 and/or entities connected thereto, e.g., such as administrator 213. According to an example, the secure software environment 236 may generate and/or store various pairs of cryptographic keys, each including a respective private key and public key pair configured to authenticate access tokens used to access resource servers, e.g., using one or more APIs. In another example, each cryptographic key pair may be used in the process of encrypting and/or decrypting stored data (e.g., access tokens) according to a given encryption standard. The secure software environment 236 may thereby be able to decrypt encrypted data and process (e.g., deduplicate and/or compress) the decrypted data without exposing any of the decrypted data and/or private key information to a remainder of the processor 212. Similarly, the secure software environment 236 may be able to provide access to physical and/or logical data encryption components without exposing any of the decrypted data and/or private key information to a remainder of the processor 212., e.g., as would be appreciated by one skilled in the art after reading the present description. Implementing the secure software environment 236 in the processor 212 thereby allows for increased storage capacity and reduced compute overhead, while also maintaining strict data security.

User device 204 may be a mobile phone that includes a processor 216 coupled to memory 218. The processor 216 may receive inputs from, and interface with, user 205. For instance, the user 205 may input information using one or more of: a display screen 224, keys of a computer keyboard 226, a computer mouse 228, a microphone 230, and a camera 232. The processor 216 may thereby be configured to receive inputs (e.g., text, sounds, images, motion data, etc.) from any of these components as entered by the user 205. These inputs typically correspond to information presented on the display screen 224 while the entries were received. Moreover, the inputs received from the keyboard 226 and computer mouse 228 may impact the information shown on display screen 224, data stored in memory 218, information collected from the microphone 230 and/or camera 232, status of an operating system being implemented by processor 216, etc.

Looking to edge node 206, some of the components included therein may be the same or similar to those included in other locations of system 200, and have therefore been given corresponding numbering. For instance, controller 217 is coupled to memory 218, a display screen 224, keys of a computer keyboard 226, and a computer mouse 228, which are accessible to administrator 207, e.g., at a built-in computer terminal for the edge node 206. Additionally, the controller 217 is coupled to an AI module 238. The AI module 238 may include any desired number and/or type of AI-based models, e.g., such as machine learning models, deep learning models, neural networks, etc. Moreover, the models may be trained to perform certain procedures (e.g., identify patterns), e.g., as would be appreciated by one skilled in the art after reading the present description.

Looking now to FIG. 3A, a flowchart of a method 300 for improving the control and efficiency with which access tokens are issued and revoked across a system is illustrated in accordance with one approach. One or more of the operations in method 300 may thereby be performed in some approaches to achieve access token revocation without performing any introspection checks (e.g., at authorization servers) for the respective revocations. As noted above, this significantly reduces compute overhead.

The method 300 may be performed in accordance with the present invention in any of the environments depicted in FIGS. 1-2B, among others, in various approaches. Of course, more or less operations than those specifically described in FIG. 3A may be included in method 300, as would be understood by one of skill in the art upon reading the present descriptions.

Accordingly, each of the steps of the method 300 may be performed by any suitable component of the operating environment. For example, one or more of the operations in method 300 may be performed by a processor at a client location (e.g., see first client location 260 and/or second client location 270). The client location may also be part of a logic system group along with other components in some approaches (e.g., see logic system group 252 of FIG. 2B). In other approaches, the method 300 may be partially or entirely performed by a controller, a computer, etc., or some other device having one or more processors therein. Thus, in some approaches, method 300 may be a computer-implemented method. Moreover, the terms computer, processor and controller may be used interchangeably with regards to any of the approaches herein, such components being considered equivalents in the many various permutations of the present invention.

For those approaches having a processor, the processor, e.g., processing circuit(s), chip(s), and/or module(s) implemented in hardware and/or software, and preferably having at least one hardware component may be utilized in any device to perform one or more steps of the method 300. Illustrative processors include, but are not limited to, a central processing unit (CPU), an application specific integrated circuit (ASIC), a field programmable gate array (FPGA), etc., combinations thereof, or any other suitable computing device known in the art.

As shown, operation 302 of method 300 includes receiving an access request from a user. In some approaches, the access request is intended for (e.g., targets) resources that are included in a given server. For example, the user may be a resource owner that is preauthorized to access certain resources at a server. In response to receiving the access request, method 300 advances to operation 304. There, operation 304 includes sending a request for an access token that is associated with performing the access request. As previously mentioned, access token requests may be sent to an authorization server that stores the active (e.g., existing) access tokens and any information that is correlated therewith. For example, the authorization server may include a lookup table that correlates each access token to a corresponding user ID, the logic system group(s) that are currently issued the access token, a cryptographic key pair, etc. The access tokens may also be assigned lease times that specify how long the respective access tokens may be used without expiring, e.g., as will be described in further detail below.

In response to receiving the request, the authorization server may inspect a lookup table to determine whether the requested access token exists for the respective user that issued the request. In response to identifying an existing access token that is associated with the user, the authorization server may extract the access token and any other relevant information before returning it to the requesting user. For example, the authorization server may pair the access token with a key ID that identifies a cryptographic key pair that is correlated with the given access token. The cryptographic key pair may be used to authenticate the access token, e.g., as will soon become apparent.

While the authorization server may already include an access token that has been generated for the requesting user (e.g., resource owner) in some situations, a new access token may be generated for new users. For example, in some approaches the authorization server may determine that the requesting user and/or requested access token do not currently exist in a repository (e.g., lookup table) of active access tokens and corresponding cryptographic information. Accordingly, the authorization server may generate a new access token for the requesting user and add it to the repository. Moreover, a cryptographic key pair may be generated for the new access token, e.g., using an encryption engine.

Advancing from operation 304 to operation 306, there method 300 includes receiving the requested access token (along with any other related information) from the authorization server. As noted above, the access token may be combined with at least some cryptographic information that may be used to authenticate the access token when used over time. For instance, in preferred approaches the received access token is merged with a corresponding key ID. Accordingly, operation 308 includes causing a key ID to be extracted from the requested access token received from the authorization server. In other words, operation 308 includes extracting public cryptographic information that was received along with the access token, from the access token for further use.

From operation 308, method 300 advances to operation 310. There, operation 310 includes causing the key ID to be compared against cryptographic keys that have been previously received at a first resource server. In other words, operation 310 includes sending one or more instructions that result in the extracted key ID to be compared against the key IDs of various other public and/or private cryptographic keys that have been received at the first resource server. It follows that the one or more instructions sent in operation 310 may be received at the first resource server and performed by one or more processors therein, resulting in the first resource server actually comparing the extracted key ID to the other cryptographic keys previously received at the first resource server. In some approaches, the previously received cryptographic keys may be stored locally in the first resource server, e.g., in a local cache. Accordingly, performing operation 310 may result in the first resource server inspecting the local (e.g., internal) cache storage for matching cryptographic information.

From operation 310, method 300 advances to operation 312. There, operation 312 includes determining whether the extracted key ID matches any of the cryptographic keys at the first resource server. In response to determining that the extracted key ID matches one of the cryptographic keys at the first resource server, method 300 advances from operation 312 to operation 314. There, operation 314 includes causing the matching previously received cryptographic key(s) to be used to verify the access token. This allows for the access token to be verified locally. In other words, the cryptographic information identified in memory of the first resource server (e.g., see first resource server 262 of FIG. 2B) as matching the received access token may be used to verify the legitimacy of the access token at the first resource server itself. This is performed without sending any requests and/or instructions outside the first resource server and/or a logic system group in which the first resource server is included. This allows for cryptographic information already stored locally at the first resource server to be utilized before interacting with remote locations. Approaches herein are thereby desirably able to reduce network traffic, compute overhead, and latency.

The process of using matching previously received cryptographic key(s) to verify an access token may vary depending on the approach. In some approaches the access token verification may include determining whether each matching cryptographic key is currently valid. For instance, lease times may be assigned to each of the previously received cryptographic keys (e.g., see lookup table 258 of FIG. 2B). As used herein, “lease times” each define a period during which the respective access tokens and cryptographic information (e.g., keys) may be used before “checking back in” with a central repository or authorization server. In some approaches, the lease times may be defined in units of time, e.g., such as milliseconds, seconds, minutes, hours, days, weeks, etc. In other approaches, the lease times may be started and/or ended by predetermined conditions being met, e.g., such as a predetermined number of operations being performed using the access token, a predetermined number of failures being experienced by the requesting user, a predetermined number of subsequent access requests being received, the access token being idle (e.g., unused) for a predetermined amount of time, etc.

For example, FIG. 3B includes exemplary sub-operations of using a previously received cryptographic key to verify an access token in accordance with one approach. It follows that one or more of these sub-operations may be used to perform operation 314 of FIG. 3A. However, it should be noted that the sub-operations of FIG. 3B are illustrated in accordance with one approach which is in no way intended to be limiting.

As shown, sub-operation 350 includes inspecting a lease time associated with the previously received cryptographic key identified as matching the access token. In other words, sub-operation 350 includes examining the previously received cryptographic key to identify the lease time that is assigned thereto. In some approaches, the lease time may be appended to the respective cryptographic key, stored in a local lookup table, managed by a local clock, etc. Moreover, sub-operation 352 includes determining whether the lease time associated with the received cryptographic key has expired. In other words, sub-operation 352 includes determining whether the cryptographic key is still active (e.g., valid).

In response to determining that the lease time assigned to the matching previously received cryptographic key has not expired, the flowchart proceeds from sub-operation 352 to sub-operation 354. There, sub-operation 354 includes causing the matching previously received cryptographic key to be used to verify the access token. In other words, sub-operation 354 includes determining that the previously received cryptographic key can be used to verify the access token before returning to operation 316 of FIG. 3A, e.g., such that the previously received cryptographic key can actually be used to verify the access token.

However, in response to determining that the lease time assigned to the matching previously received cryptographic key has expired, the flowchart proceeds from sub-operation 352 to sub-operation 356. There, sub-operation 356 includes causing a request for an updated cryptographic key to be sent to the authorization server. In other words, sub-operation 356 may include sending one or more instructions that result in the first resource server sending a request to the authorization server for an updated cryptographic key.

In some approaches, a new cryptographic key with a new lease time may be returned to the first resource server and used by the first resource server to verify the access token. In other approaches, the cryptographic key may simply be issued a new lease time to reduce network and compute overhead, e.g., as would be appreciated by one skilled in the art after reading the present description. Accordingly, sub-operation 358 includes causing the updated cryptographic key, received from the authorization server, to be used while verifying the access token. Sub-operation 358 may thereby include sending one or more instructions to the first resource server in response to the first resource server receiving the updated cryptographic key. The one or more instructions ultimately cause the first resource server to use the updated cryptographic key to verify the access token. In other words, sub-operation 358 includes determining that the updated and newly received cryptographic key can be used to verify the access token before returning to operation 316 of FIG. 3A, e.g., as described in further detail below.

Returning now to FIG. 3A, method 300 advances from operation 314 to operation 316. There, operation 316 includes determining whether the access token has been verified using the local cryptographic information. In response to determining the access token has been verified, method 300 advances to operation 318 where the access token is used to create a connection between the user that originally submitted the access request (e.g., at a first client location) and the first resource server itself. In other words, operation 318 includes using the access token at least in part to grant (e.g., satisfy) the received access request. However, method 300 advances from operation 316 to operation 320 in response to determining that the access token has not been verified. In other words, method 300 advances to operation 320 in situations where the access token cannot be verified. There, operation 320 includes rejecting (e.g., failing) the access request originally received in operation 302. In some approaches one or more warnings may be issued to an administrator associated with managing the logic system group. In other approaches, one or more warnings may be sent to a resource owner that originally issued the resource access request that has been denied.

Returning now to operation 312, method 300 advances to operation 322 in response to determining that the extracted key ID does not match any of the cryptographic keys at the first resource server. In other words, method 300 advances to operation 322 in response to determining that the access token and access request cannot be verified with the information that is available at the first resource server. Accordingly, operation 322 includes causing the first resource server to initiate a request with the authorization server for the information associated with verifying the access token. It follows that in situations where cryptographic information correlated with the received access token is not identified in local memory, the first resource server initiates a request with an authorization server. The first resource server may send a request to the authorization server for cryptographic key information that is correlated with the received access token. In other words, the first resource server requests cryptographic information from the authorization server that may be used to verify authenticity of the access request received from the first client location.

The authorization server may thereby use any information associated with this request to determine whether the access token is active (e.g., has not been revoked or expired). For instance, the authorization server may compare the access token and/or extracted key ID to various existing access channels between client locations and resource servers of a given logic system group. In response to determining the received access token and corresponding key ID do not match any active entries in a lookup table, the authorization server may return a warning to the first resource server that ultimately rejects the access request received from first client location. However, in response to determining the received access token and corresponding key ID do match an active entry in a lookup table, the authorization server may return a copy of the respective cryptographic information (e.g., private and/or public cryptographic keys) to the first resource server.

Proceeding from operation 322 to operation 324, there method 300 includes causing the first resource server to use the received cryptographic information to verify the access token and access request. Accordingly, method 300 returns from operation 324 to operation 316 and makes a determination using the newly received cryptographic information, e.g., as described above.

It follows that one or more operations in method 300 may be used to desirably improve the control and efficiency with which access tokens are issued and revoked across a system. One or more of these operations may thereby be performed in some approaches to achieve access token revocation without performing any introspection checks (e.g., at authorization servers) for the respective revocations. As noted above, this significantly reduces compute overhead and substantially improves performance efficiency for the system (e.g., logic system group) as a whole. Approaches herein also provide the ability to revoke specific access tokens from individual logic system groups. It follows that access tokens may be uniquely assigned to, and managed at, each logic system group. This allows for select implementation of access tokens across the logic system groups, e.g., as would be appreciated by one skilled in the art after reading the present description.

Approaches herein achieve these improvements at least in part by selectively revoking cryptographic key pairs themselves, which results in a corresponding access token being unverifiable, effectively revoking the access token itself. Combining this with performing access token verifications locally (e.g., at a resource server itself), approaches herein are able to verify access tokens without performing additional authorization server invocation operations. Rather, resource servers utilize local information to perform the verification of access tokens. The authorization server also creates cryptographic key pairs for each user (e.g., resource owner). These cryptographic key pairs may be correlated with the actions of the respective users. For example, the authorization server may destroy (e.g., revoke) a cryptographic key pair correlated with the access token assigned to a given user in response to the user logging out of a connection to a logic system group. While copies of the access token may have been made to create additional access points to resources in the logic system group, the expiration of the lease time assigned to the underlying cryptographic key pair results in any copies of the access token (or the original access token) being unverifiable.

As noted above, while an access token may be issued from an authorization server to a specific client location (e.g., for accessing resources hosted at a given resource server), the access token itself may be copied and shared with other locations to expand access to the same or other resources. For example, a user may wish to access a second resource server from a second client location, a third resource server from the first and/or second client location, etc. Accordingly, the access token may be copied and sent to other locations. In some approaches, copies of the access token may be sent to other locations that are in the same logic system group. The access token copies may thereby be used at the respective locations to initiate access requests with resources servers, e.g., as described in the various approaches of FIGS. 2B, 3A, and/or 3B above.

Approaches herein may also be able to dynamically revoke access tokens before the respective lease times have expired. For example, the authorization server may update entries in a repository used to verify access tokens. The authorization server may selectively cause cryptographic key pairs to expire, thereby halting any use of the respective access tokens. These updates to the cryptographic key pairs may even be proactively sent from the authorization server to any resource servers with an active connection thereto. Existing access tokens may thereby be revoked on-demand, resulting in active connections to the resource servers being terminated in real-time. Furthermore, compared with conventional implementations, approaches herein do not check additional introspection for each access token verification. Approaches herein are thereby able to conserve resources (e.g., compute overhead, memory capacity, network bandwidth, etc.) at both the authorization server and the resource servers in the logic system group(s).

It will be clear that the various features of the foregoing systems and/or methodologies may be combined in any way, creating a plurality of combinations from the descriptions presented above.

It will be further appreciated that implementations of the present invention may be provided in the form of a service deployed on behalf of a customer to offer service on demand.

The descriptions of the various implementations of the present invention have been presented for purposes of illustration, but are not intended to be exhaustive or limited to the implementations disclosed. Many modifications and variations will be apparent to those of ordinary skill in the art without departing from the scope and spirit of the described implementations. The terminology used herein was chosen to best explain the principles of the implementations, the practical application or technical improvement over technologies found in the marketplace, or to enable others of ordinary skill in the art to understand the implementations disclosed herein.

What is claimed is:

1. A method, comprising:
receiving an access request targeting a first resource server;
sending a request to an authorization server for an access token associated with performing the access request;
causing a key identification (ID) to be extracted from the requested access token received from the authorization server;
causing the key ID to be compared against cryptographic keys previously received at the first resource server;
in response to the key ID matching one of the cryptographic keys previously received at the first resource server, causing the matching previously received cryptographic key to be used to verify the access token; and
in response to the access token being verified, causing the access request to be granted.

2. The method of claim 1, further comprising:
inspecting a lease time associated with the matching previously received cryptographic key; and
in response to determining that the lease time assigned to the matching previously received cryptographic key has not expired, causing the matching previously received cryptographic key to be used to verify the access token.

3. The method of claim 2, further comprising:
in response to determining that the lease time assigned to the matching previously received cryptographic key has expired, causing a request for an updated cryptographic key to be sent to the authorization server; and
in response to receiving the updated cryptographic key, using the updated cryptographic key to verify the access token.

4. The method of claim 1, wherein the operations are performed at a first client location in a logic system group.

5. The method of claim 4, wherein the authorization server is not included in the logic system group, wherein the first resource server is included in the logic system group.

6. The method of claim 4, further comprising:
sending a copy of the access token to a second client location in the logic system group;
causing the key ID to be extracted from the access token copy;
causing the new extracted key ID to be compared against cryptographic keys previously received at a second resource server associated with the second client location; and
in response to the new extracted key ID matching one of the cryptographic keys previously received at the second resource server, causing the matching previously received cryptographic key to be used to verify the access token copy.

7. The method of claim 1, further comprising:
in response to the access token not being verified, causing the access request to be denied.

8. The method of claim 1, wherein the access token is a JSON Web Token.

9. A computer program product, comprising:
one or more computer-readable storage media; and
program instructions stored on the one or more storage media to perform operations comprising:
receiving an access request targeting a first resource server;
sending a request to an authorization server for an access token associated with performing the access request;
causing a key identification (ID) to be extracted from the requested access token received from the authorization server;
causing the key ID to be compared against cryptographic keys previously received at the first resource server;
in response to the key ID matching one of the cryptographic keys previously received at the first resource server, causing the matching previously received cryptographic key to be used to verify the access token; and
in response to the access token being verified, causing the access request to be granted.

10. The computer program product of claim 9, wherein the operations further comprise:
inspecting a lease time associated with the matching previously received cryptographic key; and
in response to determining that the lease time assigned to the matching previously received cryptographic key has not expired, causing the matching previously received cryptographic key to be used to verify the access token.

11. The computer program product of claim 10, wherein the operations further comprise:
in response to determining that the lease time assigned to the matching previously received cryptographic key has expired, causing a request for an updated cryptographic key to be sent to the authorization server; and
in response to receiving the updated cryptographic key, using the updated cryptographic key to verify the access token.

12. The computer program product of claim 9, wherein the operations are performed at a first client location in a logic system group.

13. The computer program product of claim 12, wherein the authorization server is not included in the logic system group, wherein the first resource server is included in the logic system group.

14. The computer program product of claim 12, wherein the operations further comprise:
sending a copy of the access token to a second client location in the logic system group;
causing the key ID to be extracted from the access token copy;
causing the new extracted key ID to be compared against cryptographic keys previously received at a second resource server associated with the second client location; and
in response to the new extracted key ID matching one of the cryptographic keys previously received at the second resource server, causing the matching previously received cryptographic key to be used to verify the access token copy.

15. The computer program product of claim 9, wherein the operations further comprise:
in response to the access token not being verified, causing the access request to be denied.

16. The computer program product of claim 9, wherein the access token is a JSON Web Token.

17. A computer system, comprising:
a processor set;
one or more computer-readable storage media; and
program instructions stored on the one or more storage media to cause the processor set to perform operations comprising:
receiving an access request targeting a first resource server;
sending a request to an authorization server for an access token associated with performing the access request;
causing a key identification (ID) to be extracted from the requested access token received from the authorization server;
causing the key ID to be compared against cryptographic keys previously received at the first resource server;
in response to the key ID matching one of the cryptographic keys previously received at the first resource server, causing the matching previously received cryptographic key to be used to verify the access token; and
in response to the access token being verified, causing the access request to be granted.

18. The computer system of claim 17, wherein the operations further comprise:
inspecting a lease time associated with the matching previously received cryptographic key; and
in response to determining that the lease time assigned to the matching previously received cryptographic key has not expired, causing the matching previously received cryptographic key to be used to verify the access token.

19. The computer system of claim 18, wherein the operations further comprise:
in response to determining that the lease time assigned to the matching previously received cryptographic key has expired, causing a request for an updated cryptographic key to be sent to the authorization server; and
in response to receiving the updated cryptographic key, using the updated cryptographic key to verify the access token.

20. The computer system of claim 17, wherein the operations further comprise:
sending a copy of the access token to a second client location in the logic system group;
causing the key ID to be extracted from the access token copy;
causing the new extracted key ID to be compared against cryptographic keys previously received at a second resource server associated with the second client location; and
in response to the new extracted key ID matching one of the cryptographic keys previously received at the second resource server, causing the matching previously received cryptographic key to be used to verify the access token copy.
